(19) United States
(12) Patent Application Publication
(10) Pub. No.: US 2008/0203046 A1
(43) Pub. Date: Aug. 28, 2008

(54) Overhead lift storage device

(76) Inventors: Allan Friesen, Arborg (CA); Delmer Plett, Arborg (CA)

Correspondence Address: KIRBY EADES GALE BAKER, BOX 3432, STATION D, OTTAWA, ON, K1P 6N9, CA

(21) Appl. No.: 11/711,642

(22) Filed: Feb. 28, 2007

(51) Int. Cl. B66C 13/06

(52) U.S. Cl. 212/274

(57) ABSTRACT

Certain exemplary embodiments provide for an overhead lift storage device comprising a longitudinal track for overhead mount and a pulley system for guiding at least one cable-like element therethrough. Each cable-like element has a connection end configured for connection with an article to be stored in a suspended storage position. An activation system is used to operate the pulley system causing the cable-like element to raise or lower a connected article between a lowered connecting position and a suspended storage position. A weight limiting clutch is used to limit the maximum force which can be used to lift a load thereby decreasing the risk of failure of the pulley system or cable-like element. A safety catch may be incorporated into the overhead lift storage device for taking the load off of the pulley system and/or cable-like element when the article is in the suspended storage position. The safety catch interacts directly with the cable-like element or a component thereof to take the load of the suspended article and does not support the article from below.

### FIELD OF THE INVENTION

The present invention relates to overhead lift storage devices. In particular, the invention relates to overhead lift storage devices of a kind that can be used for storing items in elevated positions in order to free-up floor space, particularly, but not exclusively, in residential, commercial or industrial locations, such as garages and workshops.

### BACKGROUND OF THE INVENTION

Overhead boom or ceiling mounted lift storage devices are generally used in garages or similar settings to allow for both the storage of articles as well as the parking of an automobile at least partially within the confines of the same footprint of space. An automobile or other article may be positioned below a suspended stored article once that article has been lifted into a suspended storage position.

Overhead lift storage devices often use a pulley system comprising both ceiling and wall mounted pulleys to allow for the lifting of an article into a suspended storage position. A wall mounted crank or winch is incorporated into the pulley system and is operated to effect the raising or lowering of an article. Wall mounted cranks and winches take up valuable space and require additional pulleys and longer cables resulting in a complicated setup. A drum reel is usually incorporated into the system around which the cable is wound. Such systems are prone to entanglement of the cable when the cable is slack. Additionally, such systems are not suitable for synchronized operation of more than one cable in conditions where cables become slack.

Once in a suspended storage position, the weight of the suspended article is normally held up by either the cable and pulley system or, optionally, by support brackets which are positioned to support the suspended article from below. The support brackets can be relatively heavy depending on the lifting capacity of the device, can be awkward to position and take up some of the valuable space below the suspended article. Furthermore, depending on the shape of the article, the support brackets may not effectively balance and safely support the article and can fail resulting in the cable taking the suspended load and increasing the risk of cable or pulley system breakage and/or damage of the article and injury to those nearby.

Overhead lift storage devices which use a drum reel and winch have an inherent danger of free wheeling causing the suspended load to drop. Brake disks or latch mechanisms which may be incorporated into the drum wheel and winch are complicated and failures are a problem.

The maximum load of an overhead lift storage device is usually determined by either the strength of the cable and/or pulley system which lifts the device or the amount of force which may be applied by an operator to turn the activating crank or winch. There is a risk of overloading the storage device, thereby increasing the possibility of failure of the storage device leading to an accidental and unexpected lowering of the suspended article, potentially damaging the article and objects or people in the vicinity of the falling article.

A need therefore exists for an improved lift storage device.

### SUMMARY

Certain exemplary embodiments provide for an overhead lift storage device comprising a longitudinal track for overhead mount and a pulley system for guiding at least one cable-like element therethrough. Each cable-like element has a connection end configured for connection with an article to be stored in a suspended storage position. An activation system is used to operate the pulley system causing the cable-like element to raise or lower a connected article between a lowered connecting position and a suspended storage position. A weight limiting clutch is used to limit the maximum force which can be used to lift a load thereby decreasing the risk of failure of the pulley system or cable-like element. A safety catch may be incorporated into the overhead lift storage device for taking the load off of the pulley system and/or cable-like element when the article is in the suspended storage position. The safety catch interacts directly with the cable-like element or a component thereof to take the load of the suspended article and does not support the article from below.

An exemplary embodiment of the invention provides for an overhead lift storage device for lifting and storing an article in a suspended storage position, the overhead lift storage device comprising: a pulley system; at least one cable-like element running through the pulley system and comprising a connecting end for attachment to an article to be lifted and a fixed end for attachment to a support; a threaded rod adapted to be mounted overhead on an elevated support, the rod being rotatable to operate the pulley system to raise or lower the connecting end of the at least one cable-like element, for moving the article between a lowered position and a elevated suspended storage position, the threaded rod comprising an interface end for receiving input force to rotate the threaded rod; and a weight limiting clutch operably connected with the pulley system to limit an amount of the input force that can be transmitted to the pulley system.

Another exemplary embodiment provides for a weight limiting clutch for selectively transferring rotational force of a threaded rod running therethrough into longitudinal movement, the weight limiting clutch comprising: a clutch housing comprising a longitudinal bore therethrough; a nut assembly longitudinally slidable and rotatably mounted in the longitudinal bore of the clutch housing, the nut assembly comprising: a longitudinal threaded bore therethrough for receiving and engaging the threaded rod; and an exterior shell; a clutch engaging pin moveable between an engaged position whereby the clutch engaging pin is engaged with the exterior shell of the nut assembly and rotation of the nut assembly with the threaded rod is prevented resulting in longitudinal travel of the weight limiting clutch along the threaded rod, and a disengaged position whereby the pin is disengaged from the exterior shell of the nut assembly and the nut assembly can rotate freely with the rotation of the threaded rod and the disengaged position is achieved through longitudinal sliding of the nut assembly under load and through movement of the clutch engaging pin away from the exterior shell of the nut assembly; a nut assembly biasing means for longitudinally biasing the nut assembly in the engaged position; and a clutch engaging pin biasing means for biasing the clutch engaging pin in the engaged position; wherein the weight limiting clutch transfers rotational force input by the threaded rod into longitudinal movement when in the engaged position and disengages the threaded rod when the threaded rod provides enough force to overcome the nut assembly biasing means and the clutch engaging pin biasing means.

Another exemplary embodiment provides for a tire clamp for seating a tire of a vehicle to be lifted by a lifting device, the tire clamp comprising: a left clamp element and a right clamp element connected together at their base to define a seat for receiving a tire; a support bracket connected to each clamp element comprising a lifting point for attachment to the lifting device.

Another exemplary embodiment provides for a lifting frame for seating and supporting the tires of a vehicle to be lifted by a lifting device, the lifting frame comprising: a first side beam and a second side beam for placement on the exterior sides of the tires; a set of cross beams for each pair of tires to be seated and supported in the lifting frame, each set of cross beams comprising a forward cross beam for placement in front of the tires and a rear cross beam for placement behind the tires, the forward cross beam, the rear cross beam and the first and second sides beams defining seats for the tires of a vehicle; and a set of lifting points for attachment to a lifting device.

### BRIEF DESCRIPTION OF THE DRAWINGS

FIG. 1A is a perspective view of an exemplary overhead lift storage device according to one aspect of the present invention;

FIG. 1B is a detailed view of FIG. 1A;

FIG. 1C is a cross-sectional view of FIG. 1A further including an exemplary cable-like element and an exemplary pulley system;

FIG. 2A is a schematic diagram of an exemplary pulley system for use in an overhead lift storage device according to one aspect of the present invention;

FIG. 2B is a schematic diagram of another exemplary pulley system for use in an overhead lift storage device according to one aspect of the present invention;

FIG. 3A is a cross-sectional view of an exemplary weight limiting clutch for use with an overhead lift storage device according to one aspect of the present invention;

FIG. 3B is a perspective view of the weight limiting clutch illustrated in FIG. 3A;

FIG. 4 is a front perspective view of an exemplary nut assembly of the weight limiting clutch illustrated in FIG. 3A;

FIG. 5 is a side perspective view of an exemplary safety catch for use in an overhead lift storage device according to one aspect of the present invention;

FIG. 6 is a detailed perspective view of an exemplary pulley system, safety catch and weight limiting clutch according to one aspect of the present invention;

FIG. 7 is a perspective view of an exemplary motorcycle attachment for use with an overhead lift storage device according to one aspect of the present invention;

FIG. 8A is a perspective view of an exemplary attachment for use with an overhead lift storage device according to one aspect of the present invention; and

FIG. 8B is a detailed view of the attachment of FIG. 8A.

### DETAILED DESCRIPTION OF THE EXEMPLARY EMBODIMENTS

### Overhead Lift Storage Device

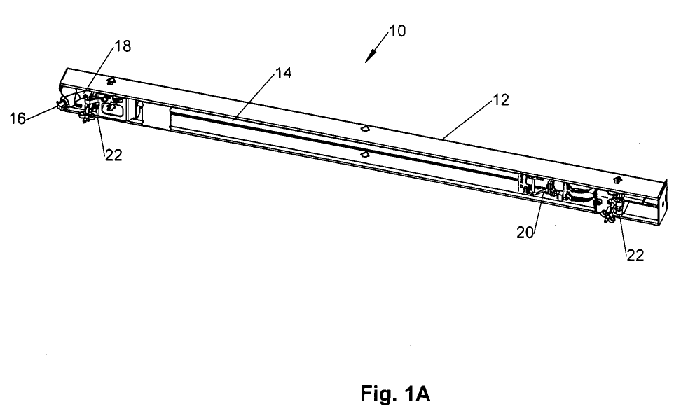

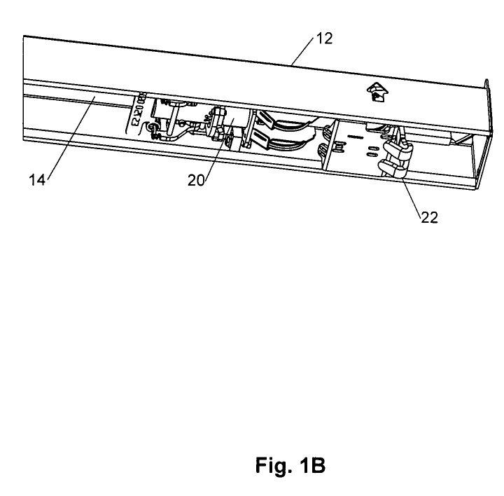

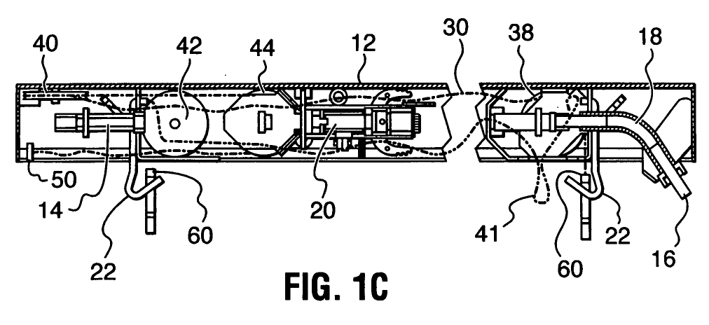

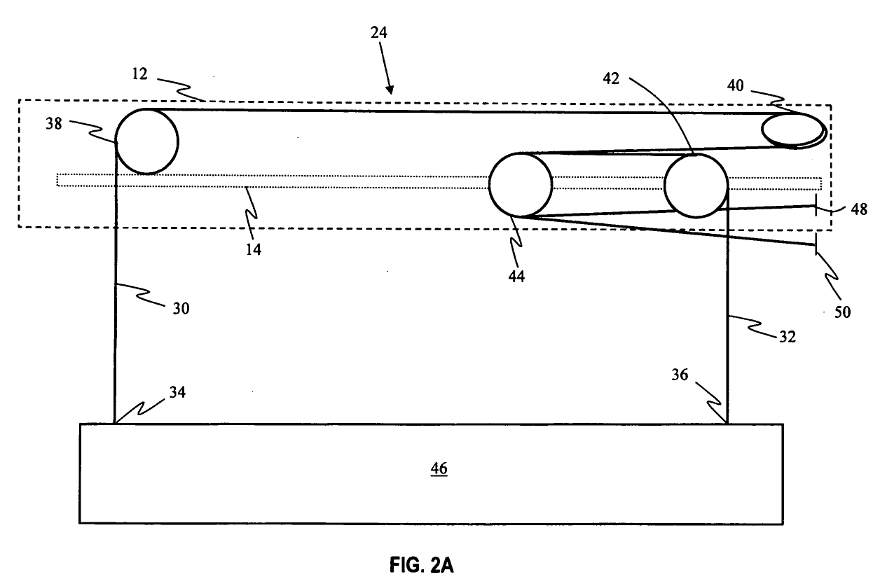

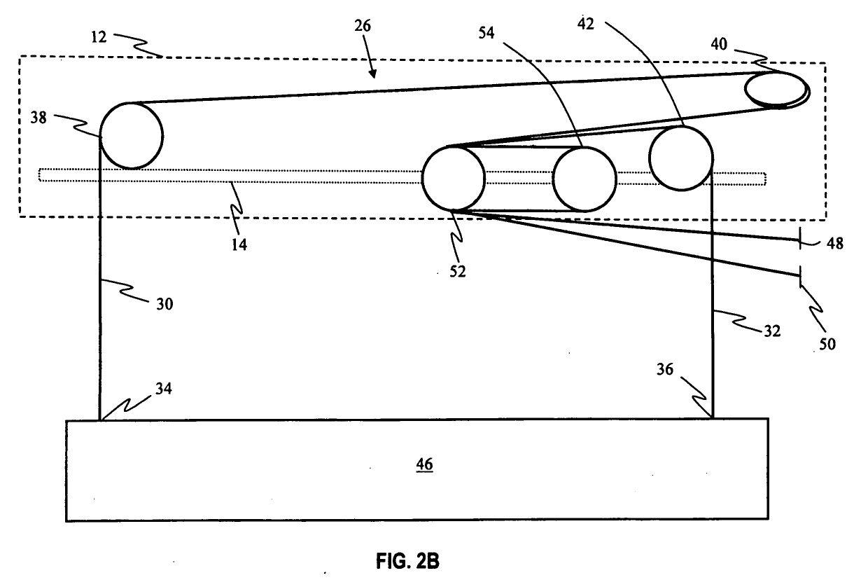

FIGS. 1A, 1B and 1C illustrate an exemplary embodiment of an overhead lift storage device according to one aspect of the present invention. The overhead lift storage device is shown generally at 10. The device includes a longitudinal track 12 designed to be mounted (e.g. by means of screws, nails, bolts, brackets, or equivalent, and with for example pre-drilled with holes therefor) on a horizontal overhead surface or support, such as a ceiling, wooden trusses, steal beams, concrete spans, a support structure, a scaffold, an overhead boom or the like. The track 12 is of box-like construction with an open lower face and at least partially houses a pulley system (shown in FIGS. 2A and 2B and discussed below) of the overhead lift storage device 10 as well as an activating rod 14 for operating the pulley system. The rod 14 is mounted for rotation in either direction within the track and it is threaded along most or all of its length. The rod is in operational communication with the pulley system such that rotation of the threaded rod raises or lowers a connecting end of one or more cable-like elements acted on by the pulley system. The threaded rod has an interface end 16 accessible to a user to rotate the threaded rod thereby operating the pulley system. The threaded rod may be selected from those having a fine or coarse thread of all sizes, an acme thread or simply any rod, shaft or tube with a threaded surface.

An optional flexible interface connector 18 may be employed to facilitate rotation of the interface end 16 of the threaded rod from a position below the overhead lift storage device 10. The flexible interface connector 18 allows for deflected rotation of the threaded rod.

The threaded rod may be driven manually either by hand or through the use of an extension such as a hand crank, wheel, sprocket arrangement or the like. Alternatively, the threaded rod may be rotated using an motorized device such as a power tool, for example a power drill, a pneumatic tool such as an air winch or air drill, a hydraulic tool or using a motor/gearbox/pulley sprocket arrangement or the like. The motorized device may be fixed to the threaded rod at an end opposite the flexible interface end 16, or alternatively, may be fixed to the interface end 16.

The pulley system may be configured to act on a single cable-like element or to act on two or more cable-like elements, each cable-like element having a lifting point at one end and a fixed attachment point at the other.

The track 12 may fully house the pulleys of the pulley system and the weight limiting clutch 20, as shown in FIG. 1C, or may alternatively only house the weight limiting clutch 20 and a portion of the pulley system.

One example of a pulley system is shown in schematic form in FIG. 2A. The system comprises fixed pulleys 38, 40 and 42 and a movable pulley 44. These pulleys may all be housed within the interior of the track 12 together with activating rod 14, and the longitudinal track 12 may be configured to guide the moveable pulley 44 as it is used for raising and lowering an article. The movable pulley 44 is carried by the activating rod 14 such that rotation of the rod in one direction causes the pulley 44 to move horizontally in one direction along the track, and rotation of the rod 14 in the other direction causes the movable pulley to move horizontally in the opposite direction. A cable-like element is threaded around the pulleys. The cable-like element may be any flexible, elongated, tensionable, linear element, such as a cable, rope, cord, string, chain, belt or the like, and is in one exemplary embodiment a stranded metal wire cable. Of course, the pulleys are designed to accommodate the kind of cable-like element employed and may be adapted to decrease the risk of derailing of the cable-like element. For convenience, the cable-like element is referred to hereinafter simply as a cable.

The embodiment of FIG. 2A has two cables 30 and 32 running through the pulley system, each having a connecting end 34, 36 for attachment to an article 46 to be lifted and an opposite end attached to a support 48, 50. The connecting ends 34, 36 lift the article 46 from a lowermost position (e.g. on the ground) into an elevated suspended storage position.

In the embodiment of FIG. 2A, cable 30 with a first connecting end 34 attached to article 46 is run through fixed pulleys 38 and 40 and then around the moveable pulley 44 and is finally anchored at position 48, which may be a point on an adjacent wall, on the longitudinal track 14 or at an equivalent location either within the track 12 or beyond the track 12. Second cable 32 having a connecting end 36 attached to article 46 is run through fixed pulley 42 and then around the moveable pulley 44 and anchored at fixed position 50. The cables may be anchored in any suitable way, including the use of eyelets. To accommodate both of the cables 30 and 32, the moveable pulley 44 may be a single double grooved moveable pulley or may be two separate moveable pulleys mounted side-by-side.

Operation of the activating rod 14 to cause movement of the moveable pulley 44 to the left results in the raising of the connecting ends 34 and 36, and hence article 46, while operation of the activating system 14 to cause movement of the moveable pulley 44 to the right results in the lowering of the connecting ends 34 and 36, and hence the article 46. Of course, instead of one article 46, two smaller separate articles may be provided, each separately connected to one of the cables 30 and 32. Alternatively, one connecting end 34 or 36 may simply not be attached to any article at all.

The pulley system 24 illustrated in FIG. 2A provides a lifting ratio of 1:2, that is to say, longitudinal movement of the moveable double pulley 44 results in twice the lifting movement of the connecting ends 34 and 36. Alternative pulley systems may incorporate fewer or more pulleys to provide the same or different lifting ratios. Typical lifting ratios may be, for example, 1:2, 2:1, 1:3, 3:1, 1:4, 4:1, etc. or alternatively a 1:1 lifting ratio.

The pulley system 24 may be set up such that the connecting ends 34 and 36 of the cables 30 and 32 are in the lowermost position when the movable pulley 44 is at one limit of its movement within the longitudinal track, and the connecting ends 34 and 36 are in their uppermost position when the movable pulley 44 is at its other limit of movement in the longitudinal track. Such a setup ensures that even when the overhead lift storage system 10 is in the lowered connecting position, there is little or no slack in the cables 30 and 32. This ensures that the risk of tangling of the cables 30 and 32 is minimized.

FIG. 2B illustrates another exemplary pulley system shown generally at 26. In this case, the pulley system 26 provides a lifting ratio of 1:4. The arrangement is essentially the same as that of FIG. 2A, except that in addition to a movable pulley 52, an additional fixed pulley 54 is provided. A first cable 30 is run through fixed pulleys 38 and 40 and then around moveable pulley 52 and fixed pulley 54 and then back around the moveable pulley 52 before being anchored at position 48. The second cable 32 is run through a fixed pulley 42 before being passed around the moveable pulley 52, the fixed pulley 54 and again around the moveable pulley 52 before being anchored at position 50. In the two cable system as shown, pulley 54 may be any combination of four single grooved pulleys, two double grooved pulleys or a single four grooved pulley, for example. Other pulley system setups may be used to provide the same 1:4 lifting ratio and are encompassed by the invention.

While the embodiments of FIGS. 2A and 2B each use two cables, the various embodiments of the invention may employ a single cable system, if desired, or more than two cables. Additionally, as well as providing a pulley system of the illustrated kind, a block and tackle system or equivalent thereof may also be incorporated into the system to change the lifting ratio.

The exemplary pulley systems 24 and 26 of FIGS. 2A and 2B provide for synchronized raising and lowering of each cable. Synchronized movement increases the safety and minimizes imbalances of the articles being lifted and suspended thereby lowering the risk of shifting, falling and damage. Additionally, synchronized or level lifting is important for the storage of motorized vehicles to ensure proper oil distribution during storage. Synchronized operation of the cables of the overhead lift storage device also allows for synchronized engagement of safety catches which take the suspended load from the pulley system and cable. Exemplary safety catches will be discussed in more detail below. Alternatively, additional activation and pulley systems may be incorporated into the overhead lift storage device to permit for independent operation of each cable of the device.

Each connecting end 34 and 36 of each cable may comprise an additional device to facilitate connection with an article to be lifted. For example, a hook, ring, eye loop, clamp, threaded bolt, friction connector, interference fit connector, strap, rope, adhesive or Velcro®, or any combination thereof, may be used to facilitate connection of each cable to the article. Each connection end 34 and 36 may be different and chosen independent of each other. Alternatively, the connection ends 34 and 36 may be connected using a bridge or scaffold or the like to facilitate the lifting of articles of appropriate dimensions or shape which would be safely accommodated by such a connection. Additionally, a splitter or Y-cable, comprised for example of a chain or cable, may also be used separate or in addition to other connection devices to increase the number of lifting points and/or to accommodate suitable articles.

### Weight-Limiting Clutch

The illustrated embodiment includes a weight limiting clutch 20 to protect the equipment from overload. The weight limiting clutch 20 may be a torque sensitive pressure spring, a pressure slip clutch, a clutch which uses a shear pin, an electronic weight limiting and/or travel limiting clutch, etc. Any electronic or non-electronic clutch may used, provided that the predetermined maximum force or weight is limited by the clutch thereby increasing safety and longevity of the overhead lift storage device.

The weight limiting clutch 20 ensures that a lifting force which is greater that a predetermined lift capacity of the overhead lift storage device 10 cannot be used to lift an article which would overload the device and possibly damage the device, snap a cable 30 or 32 or break the pulley system 24 or 26 resulting in the dropping of an article from a suspended position or damage resulting from a cable snapped under tension. The weight limiting clutch 20 may be incorporated between the activating rod 14 and the moveable pulley 44 (FIG. 2A) or 52 (FIG. 2B), along the activating rod 14, on the interface end 16 of the activating rod or in any other position providing that the input force is transmitted through the weight limiting clutch 20. In those cases where the weight limiting clutch 20 is associated with the movable pulley 44 or 52, the longitudinal track 12 and weight limiting clutch 20 may be configured to interface such that longitudinal travel of the weight limiting clutch 20 is guided by the longitudinal track 12.

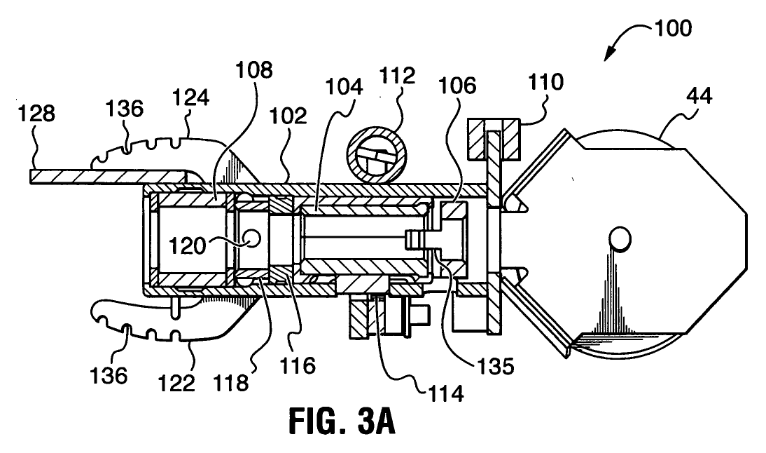

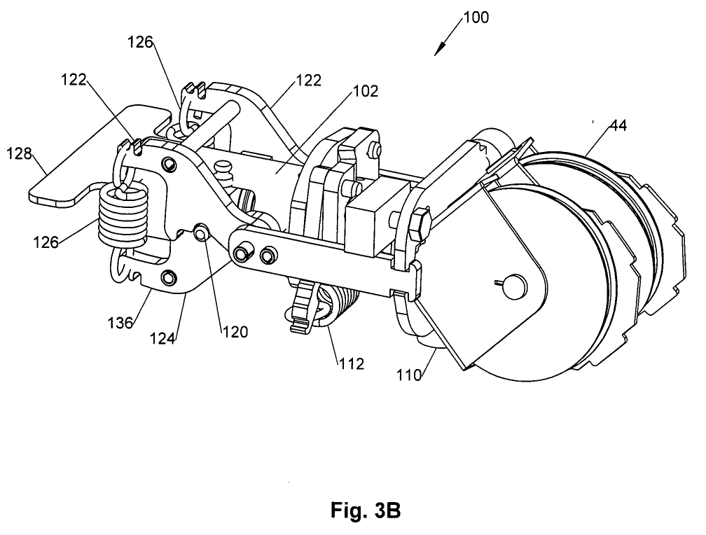

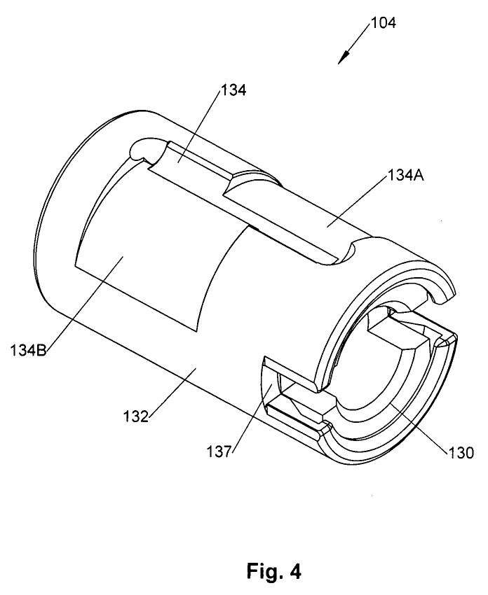

FIGS. 3A, 3B and 4 illustrate an exemplary weight limiting clutch. In these drawings, the clutch is identified generally by the numeral 100 and comprises a clutch housing 102 which has a longitudinal bore therethrough for supporting and/or housing subassemblies of the clutch 100. Clutch housing 102 is cylindrical with a longitudinal axis, and is made, for example, of steel; however, alternative shapes, such as cubic or multiangular, and alternative materials, such as stainless steel, aluminum, composites or alloys, may be used, if desired.

Contained within the clutch housing 102 in slidable, rotational, relation therewith, is a nut assembly 104. The nut assembly engages the threaded rod 14 (see FIGS. 1A and 1B) and transfers the rotational motion of the threaded rod into longitudinal motion, thereby moving the clutch housing 102 along the track. The nut assembly 104 comprises an inner longitudinal threaded bore, shown as 130 in FIG. 4, engaging the threaded rod. In this embodiment, the inner longitudinal threaded bore 130 is provided in an inner nylon sleeve which reduces friction and aides is reducing thermal overload of the threads. Teflon®, plastics and other types of nylon may also be used to form the inner longitudinal threaded bore 130. Other alloys or metals may be used for the inner longitudinal threaded bore, optionally in cooperation with an air or liquid cooling device as required. An exterior shell 132 (which may be made, for example, of steel, stainless steel, bronze, aluminum, an alloy or composite) of the nut assembly is configured to partially receive a clutch engaging pin 114 (FIG. 3A) within a groove 134 (FIG. 4) provided for this purpose. The clutch engaging pin 114 is accommodated within an opening in the clutch housing 102 and is biased to engage the exterior shell 132 of the nut assembly 104 and substantially prevent rotation of the nut assembly 104 within the clutch housing 102 during rotation of the threaded rod. As the clutch housing 102 cannot rotate (because it is guided on the track for translational but not rotational movement), rotation of the rod causes translational movement of the clutch housing 102.

Any biasing means may be used to bias the clutch engaging pin 114 into the engaging position within the groove 134. For example a coil spring 112 encircling the clutch housing 102 may achieve this function. A trip mechanism may be used together with a coil spring to bias the clutch engaging pin 114 between the engaged position and the disengaged position. The clutch engaging pin 114 and the exterior shell 132 of the nut assembly 104 are configured to allow for longitudinal sliding of the nut assembly 104 in the clutch housing 102. When the engaging pin is engaged with the nut assembly 104 to prevent relative rotation between the nut assembly and the exterior shell 132, rotational force provided by the threaded rod is transferred through the clutch and directly to the pulley system of the overhead lift storage device. When the nut assembly 104 and the engaging pin 114 are engaged together, rotation of the threaded rod consequently results in the longitudinal displacement of the weight limiting clutch 100 along the threaded rod and along the longitudinal track of the overhead lift storage device. A moveable pulley, for example moveable pulley 44 of the pulley system of FIG. 2A, is mounted on and supported by the weight limiting clutch 100 to thereby allow for the rotational force provided by the threaded rod to be converted to translational movement of the movable pulley and pulling of the associated cable. As noted above, moveable pulley 44 may be any combination of multi- or single-grooved pulleys for providing a desired lifting ratio for a desired number of lifting cables.

When the clutch engaging pin 114 is moved against the bias of the spring 112 and out of the engaging position away from the nut assembly 104, the nut assembly 104 may rotate freely with the threaded rod without resulting in longitudinal movement of the weight limiting clutch 100 along the threaded rod, and without resulting in operation of the pulley system. The exterior shell 132 of the nut assembly 104 may be configured such that longitudinal sliding of the nut assembly 104 exposes the clutch engaging pin 114 to a ramped section 134A of the exterior shell 132 which facilitates disengagement of the clutch engaging pin 114 from the nut assembly 104. The exterior shell 132 may be configured to facilitate disengagement during longitudinal sliding in one or both directions, i.e. by providing a second ramped section 134B on the opposite side of groove 134, the ramped sections being laterally displaced along the groove.

Also housed in sliding relation within the clutch housing 102 is a thrust bearing 116. Under load, the thrust bearing 116 is caused to slide longitudinally within the clutch housing 102 as a result of contact with the nut assembly 104. The thrust bearing 116 comprises a series of bearings which contact the nut assembly 104 and allow for low friction rotation of the nut assembly 104 during slippage and disengagement of the nut assembly 104 from engaging pin 114. The thrust bearing 116 may comprise roller, ball or needle bearings. Alternatively, the thrust bearing 116 may be replaced by one or more washers which may affect the longevity and performance of the weight limiting clutch 100.

The thrust bearing 116 also contacts a clutch yoke 118. The clutch yoke 118 is in slidable relation within the clutch housing 102 and operates a first cog set 122 and a second cog set 124 via one or more cog pins 120. The cog pins 120 are connected at or near one end to the clutch yoke 118 and at an opposite end control movement of the pivotally mounted first and second cog sets 122 and 124. The first and second cog sets 122 and 124 each include at least one pivotally mounted cog. The first and second cog sets 122 and 124 may be mounted opposing each other substantially pivoting in the same plane such that they may be pivoted towards and away from each other. Pivoting of the first and second cog sets 122 and 124 is controlled by the longitudinal travel of the cog pins 120 which pivot the first and second cogs towards and away from each other. The first and second cog sets 122 and 124 are configured, using for example an aperture, an indentation, a step, a shoulder or the like, to seat and guide the cog pins 120 such that longitudinal travel of the clutch yoke 118 in one direction pivots the cogs 122 and 124 toward each other, while longitudinal travel of the clutch yoke 118 in an opposite direction pivots the cogs 122 and 124 away from each other.

The cogs may be biased in an operating position, towards each other, such that the clutch yoke 118 is biased toward the thrust bearing 116 and nut assembly 104. One or more coil springs 126 may be used to bias the first and second cog set 122 and 124 toward each other. When lifting an article, the nut assembly 104 slides towards and applies a longitudinal force to the thrust bearing 116 and the clutch yoke unit 118 against the bias of the first and second cog set 122 and 124 via the cog pins 120. If the longitudinal force is greater than the biasing force provided through the first and second cog sets 122 and 124, the first and second cog sets 122 and 124 are pivoted apart allowing for additional longitudinal sliding of the nut assembly 104, the thrust bearing 116 and the clutch yoke unit 118. The additional sliding which occurs when the first and second cog sets 122 and 124 are pivoted apart, results in the disengagement of the clutch engaging pin 114 from the nut assembly 104 via the ramped section 134A, thereby allowing for the free rotation of the nut assembly 104 with the threaded rod and halting the longitudinal travel of the weight limiting clutch 100 along the threaded rod. The weight of an article to be lifted is thereby limited by the magnitude of the biasing force against the sliding movement of the nut assembly 104, the thrust bearing 116 and the clutch yoke unit 118. The first and second cog sets 122 and 124 may be configured as a trip mechanism such that they are substantially either in the engaged position, whereby the biasing force is applied against the clutch yoke 118 towards the nut assembly 104, and an unengaged position, whereby little to no bias is applied against the clutch yoke 118 towards the nut assembly 104 and the nut assembly is substantially free to slide longitudinally out of engagement with the clutch engagement pin 114.

In order to allow for variations in the spring force provided by the springs 126, the first and second cog sets 122 and 124 may comprise various pairs of attachment points 138 for the springs 126 arranged at varying distance apart. The attachment points 138 may take the form of indentations, as shown, or a groove or aperture.

A separate cog pin may be used for each cog set, each cog of each cog set, or a single cog pin may be used to operate the pivot of all of the cogs.

The weight limiting clutch 100 may also comprise a spring sleeve 108 for biasing the clutch yoke unit 118 towards the nut assembly 104. The bias provided by the spring sleeve 108 may used to reposition the first and second cog sets 122 and 124 back into an engaging position after slippage of the clutch. The spring sleeve 108 may be made of a resilient material, such as a urethane, or may be a coil spring made of steel or an alloy. Alternatively, the first and second cog sets 122 and 124 may be replaced entirely by the spring sleeve 108 if made sufficiently resilient to bias the nut assembly to the operating position during normal use. Even when the cogs sets are present, the force of the spring sleeve 108 may be used to at least partially control the weight limit of an article to be lifted by the weight limiting clutch 100.

To increase safety in the event that the threads along the longitudinal threaded bore 130 of the nut assembly 104 are stripped, a safety nut 106 may be placed within the clutch housing 102. The safety nut 106 is configured to engage the nut assembly 104 and has an interior thread which engages the threaded rod if the interior thread of the nut assembly 104 is stripped and can support the weight limiting clutch 100 and prevent slippage of the stripped weight limiting clutch 100 and the accidental dropping of a suspended article. In order to reduce drag and/or heat generated from the safety nut, the internal bore may be slightly larger than the diameter of the threaded rod, thereby reducing resistance between the safety nut 106 and the threaded rod, during rotation of the threaded rod. The safety nut may be made of any suitably strong material, e.g. an alloy or metal, for example, brass.

The safety nut 106 may be configured to serve a secondary purpose. When the nut assembly 104 has an inner sleeve made of nylon, an inner longitudinal threaded bore 130 and a steel exterior shell 132, the safety nut 106 may comprise an additional tongue 135 for interaction with the nut assembly to prevent the nylon inner sleeve from rotating within the steel exterior shell 132. In such an embodiment, the nut assembly 104 comprises a groove 137 adapted to receive the tongue 135 or the like in the safety nut 106. It is not necessary that the interaction of the tongue 137 and groove 135 between the safety nut 106 and the nut assembly 104 be precise, so long as the tongue may interact with both at least a portion of the nylon inner longitudinal threaded bore 130 and at least a portion of the steel exterior shell 132. Alternatively, if other suitable materials are used for the inner longitudinal threaded bore 130 and the exterior shell 132 other than nylon and steel, respectively, the safety nut 106 and the nut assembly 104 may comprise the tongue 137 and groove 135 interface. The tongue 137 and groove 135 interface may further be used to lock the safety nut 106 with the nut assembly 104 in the event that the inner longitudinal threaded bore 130 is stripped and the safety nut 106 must be used to engage the threaded rod or other activating system.

The maximum weight limit or the limit of force transferred between the threaded rod and pulley system is determined by the magnitude of the biasing forces applied from the clutch yoke unit 118 towards the nut assembly 104 and by the clutch engaging pin 114 against the nut assembly 104. The biasing rates, for example the springs 112 and/or 126, may be varied to change the magnitude of the load limited by the weight limiting clutch 100. The maximum weight limit or the limit of force transfer between the threaded rod and the pulley system may further be controlled by the configuration of the exterior shell 132 of the nut assembly 104.

Additionally, the nut assembly 104 may also be disengaged from the clutch engaging pin 114 if the weight limiting clutch 100 encounters a travel limiter on the threaded rod. The travel limiter, for example a stop ring or the like on the threaded rod, would impede the movement of the nut assembly 104 along the threaded rod and would impart enough force against the clutch housing 102 to overcome the biasing forces and longitudinally slide the nut assembly 104 out of the engaged position and halt the longitudinal travel of the weight limiting clutch 100 along the threaded rod.

The exterior shell 132 of the nut assembly 104 may be configured such that longitudinal sliding of the nut assembly 104 in both directions within the clutch housing 102 would disengage the nut assembly 104 from the clutch engaging pin 114. Thus an additional ramp 134B is provided on the opposite side of the groove 134 to the ramp 134A and the two ramps are longitudinally displaced.

A suitable lubricant may be used to reduce friction between adjacent and moving components and extend the operational life of the weight limiting clutch 100.

The weight limiting clutch 100 may further comprise one or more guides for use in conjunction with the longitudinal track 12 of the overhead lift storage device 10. The guides are configured to allow for longitudinal travel of the clutch 100 in the longitudinal track 12 and furthermore to inhibit rotation of the clutch. Thus, a guide arm 128 is used to allow for longitudinal travel in a receiving guide (not shown) in the longitudinal track 12, while a guide button 110 is used in cooperation with a button guide (not shown) in the longitudinal track 12 to prevent rotation of the weight limiting clutch 100.

As well as providing a safety clutch, the illustrated apparatus may have additional safety features.

### Safety Catch

The overhead lift storage device of certain exemplary embodiments is provided with one or more safety catches intended to relieve the pulley mechanism of the weight of the article being stored after the article has been hoisted into an elevated position, thereby increasing the safety and longevity of the device.

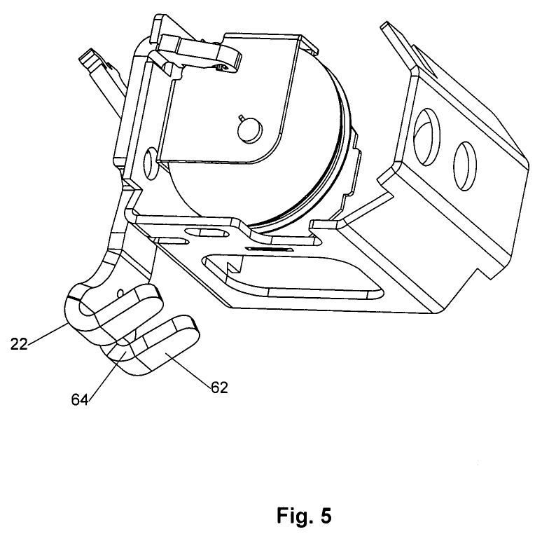

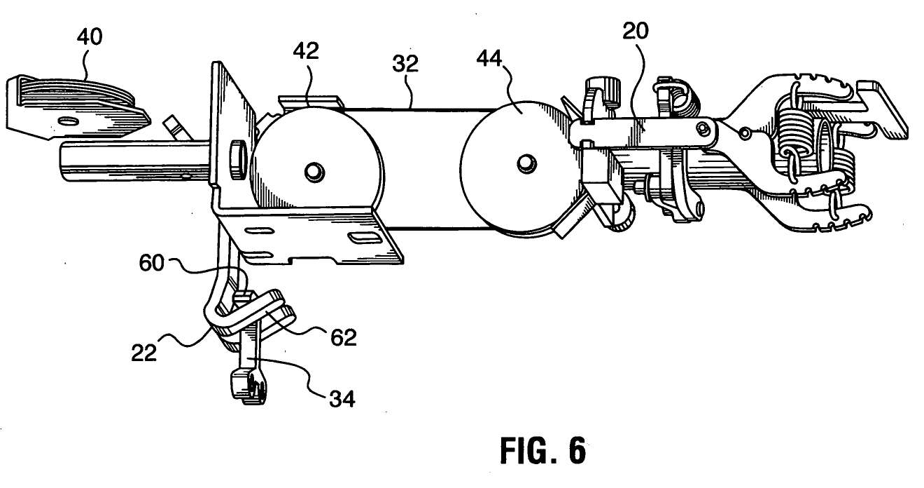

FIG. 5 and FIG. 6 illustrate an exemplary safety catch 22 which may be mounted either on the longitudinal track 12 or attached directly to an overhead surface. Such a safety catch 22 may be incorporated into the overhead lift storage device 10 for each cable thereof. Each safety catch 22 is configured to take the load off of the pulley system 24 or 26 and optionally the cable as well. As such, in the event of failure of the pulley system 24 or 26 or optionally the cable 30 or 32, when in the suspended storage position, the safety catch 22 can suspend the article in the suspended storage position. This precaution decreases the risk of accidental dropping of the article and damage to the article or surrounding objects.

An exemplary safety catch 22 is supported by the longitudinal track 12 and engages a safety shoulder 60 attached or integrated into the cable 30 or 32. The safety shoulder 60 may be integrated into the connecting end 34 or 36 of the cable 30 or 32. A beneficial result of integrating the safety shoulder 60 into the connecting end 34 or 36 of the cable 30 or 32 is that the connecting end 34 or 36 may be reinforced or stronger than the cable itself thereby ensuring that the safety catch has a greater shear strength or higher support limit than the cable 30 or 32.

The safety catch 22 may be rotatably mounted between an engaging position whereby the safety catch 22 engages the safety shoulder 60 and supports the article and a non-engaging position whereby rotation of the safety catch 22 disengages the safety shoulder 60 allowing for the lowering of the article. The safety catch 22 may be biased in the engaging position. Additionally, the lower surface 62 of the safety catch 22 may be slanted to allow for the safety shoulder 60 to rotate the safety catch 22 out of the engaging position upon upward pressure from below by the safety shoulder 60 allowing for the passage of the safety shoulder 60. This type of movement would be experienced during the lifting of the article and would ensure that the safety catch 22 was automatically engaged after an article was lifted a predetermined amount or completely into the suspended storage position. If the safety shoulder 60 is positioned on the connecting end 34 or 36 of the cable 30 or 32, than the article must be lifted completely into the suspended storage position before the safety catch 22 will engage the safety shoulder 60 and support the article.

Longevity of the overhead lift storage device 10 and safety are increased if the safety catches 22 are used to support the article when in the suspended storage position. This can be done by raising the article to point where the safety shoulder 60 upwardly passes the safety catch 22, and then lowering the article until the safety catch 22 engages the safety shoulder 60.

The safety shoulder 60 may be a bulb, shoulder, T-shaped, L-shaped or the like, provided that the safety shoulder 60 is sufficiently strong to support the article and shaped appropriately to engage the safety catch 22.

Alternatively, the safety catch 22 may comprise of gripping or pinching arms which grip or pinch the cable with enough force to take the load from the pulley system 24 or 26. The gripping or pinching arms may further be used in conjunction with a safety shoulder 60, to decrease the amount of pinching force required.

The optional safety catch 22 may be manually releasable, electronically controlled, hydraulically controlled, mechanically controlled or pneumatically controlled. A disengaging cable 41 (shown in FIG. 1C), such as a trip cable, may be used to disengage each or all of the safety catches 22 of the overhead lift storage device 10. For example, the disengaging cable may rotate each safety catch 22 against the bias and out of the engaging position to thereby allow for the downward passage of the safety shoulder 60. The safety catch 22 may further include an aperture or indentation to allow for the passage of the cable 30 or 32 even when in the engaged position. Moreover, the disengaging cable 41 may comprise of a cable attached both safety catches 22 with a second cable extending from one safety catch 22 configured such that pulling on the second cable, simultaneously releases both safety catches 22. This concept may be expanded if more than two safety catches 22 are used in a single overhead lift storage device.

To lift an article into a suspended storage position using the overhead lift storage device 10 illustrated in FIGS. 1 and 2A, the activation system 14, for example a threaded rod, is rotated in a direction to lower the cable attachment ends 34 and 36 into a position suitable for attachment with an article or articles to be lifted. The connection end 34 and 36 of each cable 30 and 32 is attached to the article or articles, optionally using an attachment device such as those mentioned above. The threaded rod is then rotated in the opposite direction thereby moving the moveable pulley 44 and raising the article. Rotating force is transferred through the weight limiting clutch 20 which directly or indirectly transfers the rotating force to the pulley system 24. If too much force is input into the weight limiting clutch 20, the weight limiting clutch 20 disengages the pulley system 24 from the rotating force thereby preventing the lifting of the article. If the rotating force is of an acceptable magnitude, the force is transferred to the pulley system 24 and the article is raised. If the overhead lift storage system 10 comprises an optional safety catch 22 as shown in FIG. 3 and a safety shoulder 60 attached to the connection end 34 and 36 of cables 30 and 32, the article is lifted until the safety shoulder 60 has biased the safety catch 22 out of the engaging position and passed above the safety catch 22. The safety catch 22 is repositioned back into the engaging position after upward passage of the safety shoulder 60 for interaction with the safety shoulder 60 upon lowering of the cables 30 and 32. As mentioned above, the safety catch 22 may be rotatably mounted and biased in an engaging position such that the safety catch 22 automatically repositions itself in the engaging position after allowing upward passage of the bulb, shoulder or the like.

Once in the suspended storage position the article is supported by either the cable 30 and 32 and the pulley system, or optionally by one or more safety catches 22. Each cable 30 and 32 may be attached to the article to be lifted at any suitable lifting point thereby allowing for a balanced lift of the article. Optionally, some or all of the cable connecting ends 34 and 36 may be connected to each other by a bridging element or scaffold upon which the article may be supported. The bridging element may be rigid, for example a plank, or may be flexible, for example a belt.

To lower and detach the article from the suspended storage position, the optional safety catches 22 must first be disengaged. This may require the slight raising of the article to disengage the safety shoulder 60 from the safety catch 22. Once the safety shoulder 60 and safety catch 22 are disengaged, the safety catch 22 may be moved or rotated out of the engaging position and the article lowered using the activating system 14, for example by rotating the threaded rod. Once lowered to the desired position or height, the connecting end 34 and 36 of each cable 30 and 32, may be detached from the article.

The safety catches 22 may further be used in conjunction with an overhead lift storage device comprising a pulley system configured to allow individual or independent raising and lowering of the cables of the device. For example, each cable may not be lowered until the associated safety catch 22 is disengaged.

Operation of the activating system 14 may be done manually using a hand crank or the like or may be done automatically using a power tool or the like. For manual operation of the activating system 14, rotation of the threaded rod may be achieved through the attachment of a hand crank to the interface end 16. As the lift device is mounted overhead, a flexible interface connector 18 may optionally be incorporated to permit the deflection of the interface end 16 to facilitate operation from a position below the device. Input force or turning force is limited through the weight limiting clutch 20 to ensure that the lift device 10 is not overloaded. The activating system may optionally comprise travel limiters (not shown) which serve to limit the travel of the pulley system to ensure that an article is not lifted too high or beyond the operating limits of the lifting device 10. The travel limiters may be an unthreaded section or equivalent thereof along the threaded rod which blocks or stops movement of the pulley system. The travel limiter may be selected from any physical device, including a stop ring, or any electrical sensor, including an optical sensor, providing that the travel of the pulley system is directly or indirectly limited. The travel limiter may interact with either the pulley system 24 or 26 or the weight limiting clutch 20 to disengage the pulley system 24 or 26 from the activating system 14 thereby preventing operation of the pulley system 24 or 26 through the activating system 14. Disengagement may be done through the weight limiting clutch 20 and be carried out when the weight limiting clutch 20 physically contacts the travel limiter.

The activating system 14 may optionally be operated by a power tool. The power tool may be incorporated or integrated into the overhead lift storage system 10. For example, a power drill may be operatively connected to the activating system, for example a threaded rod. The power drill may then be used to rotate the threaded rod in either direction thereby raising or lowering the cables 30 and 32 between a suspended storage position and a lowered connecting position. Alternatively, other power tools, pneumatic tools or hydraulic tools may be used to operate the activating system 14. Moreover, the tools may be electronically controlled by a switch for use by an operator to operate the activating system from a point remote the overhead lift storage device 10, for example outside of a garage or inside of a house or office. An infrared activator may also be used, from for example, a car mounted switch similar to a garage door opener.

Optionally, the tool may incorporate a weight limiting clutch 20 such that input force is limited between the tool and the activating system 14 to thereby limit the amount of weight that can be lifted or suspended by the pulley system. For example, the tool may be a torque adjustable drill. In manual operation, a similar principle applies, such that, for example, a torque wrench could be used to operate the activating system 14.

In another exemplary embodiment, the activating system 14 may comprise a hydraulic or pneumatic system for controlling the operation of the pulley system. When a hydraulic system or pneumatic system is used to operate the pulley system, the maximum weight limit of an article to be lifted or the corresponding magnitude of force imparted by the hydraulic or pneumatic system may be limited by a pressure release valve in operational communication with the hydraulic or pneumatic system.

### Optional Attachments

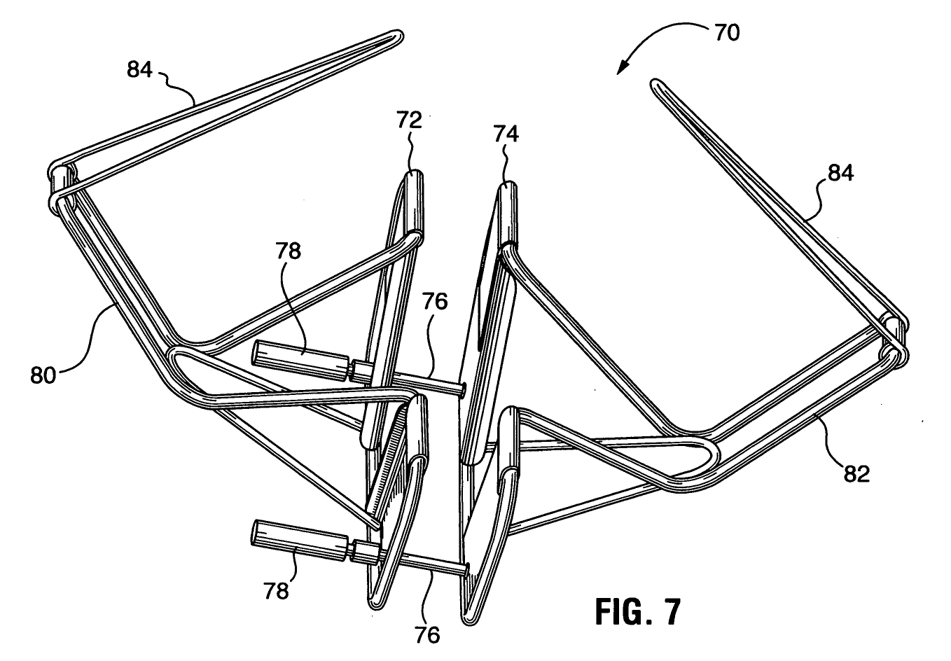

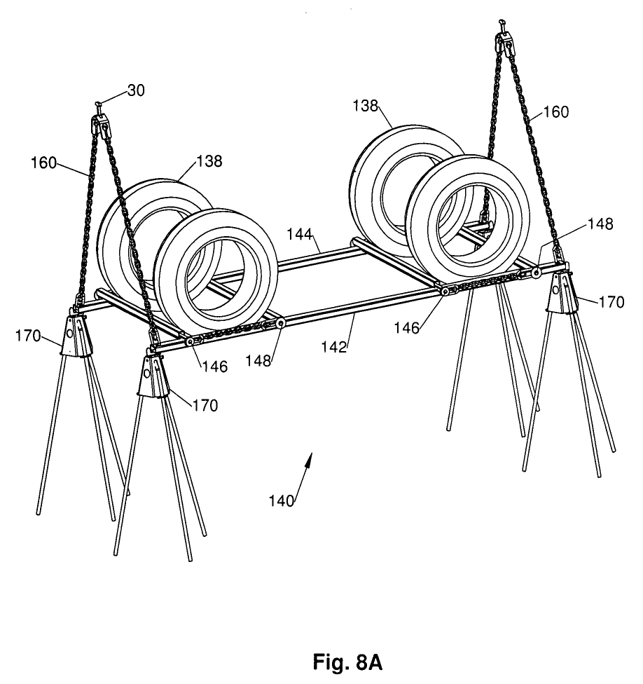

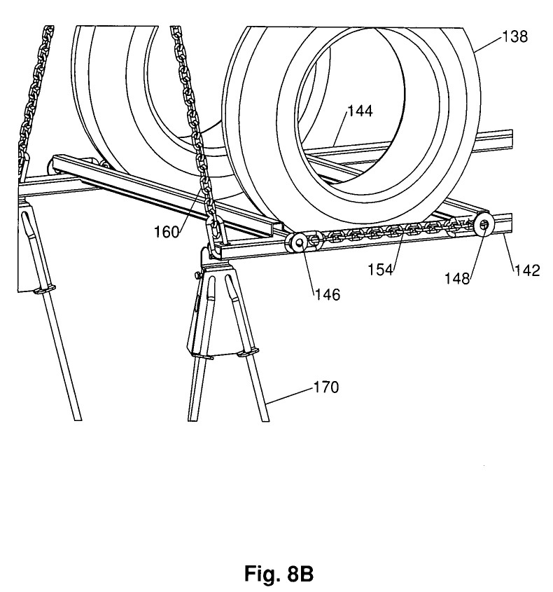

Specialized attachments may be used with the overhead lift storage device to lift particular articles, for example motorcycles, bicycles, personal watercraft including motorized and non-motorized craft, lawn mowers including riding and non-riding mowers, all-terrain vehicles, other non-uniform shaped articles, etc. A specialized motorcycle attachment and a specialized ATV attachment will be described in detail below with reference to FIGS. 7, 8A and 8B.

FIG. 7 illustrates an exemplary tire clamp for use for example on a motorcycle for attachment to the connecting ends a cable of an overhead lift storage device. The tire clamp is shown generally at 70. The exemplary tire clamp 70 is configured for rolling or lifted entry of a wheel and tire of a motorcycle or the like. However, the wheel and tire of a bicycle or other two-wheeled vehicle may also be wheeled or lifted into the tire clamp 70.

The tire clamp 70 comprises a left clamp element 72 and a right clamp element 74 for clamping the sides of the wheel and tire therebetween. The clamp elements 72 and 74 are connected together, for example at their base. For example, a connecting pin 76 may be used to connect the clamp elements 72 and 74 together. A connecting pin 76 may be used towards each end of the clamps elements 72 and 74 forming a seat for the wheel and tire to settle therein thereby increasing the stability of the motorcycle when clamped. The clamp elements 72 and 74 may be adjustably connected together to allow for different widths of tire and wheel to be inserted therebetween. An adjustment knob 78 may be used in conjunction with the connecting pin 76 to adjust the distance between the clamp elements 72 and 74. For example, the connecting pin 76 and adjustment knob 78 may be thread adjustable, friction adjustable, interference fit adjustable, etc. The tire clamp 70 is connected to the connecting end 34 or 36 of a cable 30 or 32 on both sides of the clamp by a left support bracket 80 and a right support bracket 82 using a Y-cable adapter or splitter or the like. Each support bracket 80 and 82 is attached to a clamp element 72 or 74 at one end and is connected to a lift arm 84 at they other end. Each lift arm 84 may comprise an arm of a suitable length and extends at a suitable angle for connection to the overhead lift storage device. The lift arm 84 is adapted for attachment to the Y-cable, splitter or the like and may be pivotally connected to the support bracket 80 and 82 via, for example a hinge. The Y-cable, splitter or the like may be a chain, cable, belt or equivalent thereof. Each support bracket 80 and 82 may be configured and attached such that upward lifting at the lifting arm 84 causes some inward pivot of the upper portion of each clamp element 72 and 74 causing additional pinching of the wheel and tire positioned therebetween. Additional pinching of the wheel and tire increases stability of the motorcycle mounted in the tire clamp 70. A tire clamp 70 is used for each tire of the motorcycle with a Y-cable, splitter or the like attaching to each connecting end 34 and 36 of each cable 30 and 32 respectively. Synchronous lifting of each tire clamp 70 may then be carried out using the overhead lift storage device 10 increasing stability and balance of the motorcycle as well as normal oil distribution in the motorcycles engine.

Alternatively, the support brackets 80 and 82 may be configured and mounted such that inward pivot of the upper portion of each clamp element 72 and 74 is avoided and pinching of the tire and wheel is derived through adjustment of the distance between the clamp elements 72 and 74. Optionally, the adjustment knob 78 may be omitted from the tire clamp 70, and stability may be achieved solely by the inward pivot of the upper portion of each clamp element 72 and 74 when lifted by the support brackets 80 and 82.

The tire clamp 70 may be comprised of steel, stainless steel, aluminum, alloys, composite material, plastics or combinations thereof.

If connecting to an overhead lift storage device having four cables with connecting ends, the Y-cable, splitter or the like may be omitted, and the support brackets 80 and 82 may be connected directly to each connecting end at the lift arm 84.

FIGS. 8A and 8B illustrate an exemplary ATV or riding mower lifting frame shown generally at 140. The lifting frame 140 may be used to lift any four-wheeled or even wheeled vehicle of a suitable weight to be lifted and stored by an overhead lift storage device such as the exemplary device shown generally at 10 in FIG. 1A. The lifting frame 140 may also be used with suitable tracked vehicles if required.

The lifting frame 140 is comprised of a first side beam 142 and a second side beam 144 for placement on the outer sides of the tires 138 of the device to be lifted and stored. Cross beams 146 and 148 are placed in front of and behind each set or tires to secure the vehicle on the lifting frame 140 and inhibit the rolling ability of the tires 138. The cross beams 146 and 148 may be of a fixed length or may be telescopically adjustable in length. Additionally, if the cross beams 146 and 148 are telescopically adjustable, they may be biased in a retracting position to impart an inward force on each of the side beams 142 and 144, when attached to the side beams. Such an inward force can increase the stability of the vehicle on the lifting frame 140. Each side beam 142 and 144 may comprise one or more attachment points such as a hole, friction fit device, interference fit device, threaded engagement device or the like. Alternatively, the cross beams 146 and 148 may be slidably connected to the side beams 142 and 144 for lengthwise adjustment to fit a desire vehicle layout. An optional connecting device 154, such as a chain, cable or rope may be used to connect each end of each cross beam 146 and 148 for a set of tires. Additionally, each connecting device 154 may be biased in a tightening position such that the cross beams 146 and 148 are pulled towards each to impart pressure on each end of each set of tires 138.

The lifting frame 140 may be attached to an overhead lift storage device such as that illustrated generally at 10 in FIG. 1A, for lifting the vehicle into a suspended storage position. A Y-cable 160, such as a cable, rope, chain or the like, may be attached at each end of the lifting frame 140 and attached to a lifting cable 30 and 32 of the an overhead lift storage device.

Once elevated, an optional support device 170 may be positioned and optionally secured under each corner of the lifting frame 140. The support device may be a tripod or other support device such as a scaffold or the like. The support frame may then be optionally detached from the overhead lift storage device and the vehicle may be stored or serviced as desired.

The above description of the exemplary embodiments should not be interpreted in any limiting manner as variations and refinements are possible which are within the scope of the invention. The scope of the invention is defined in the appended claims and their equivalents.

1. An overhead lift storage device for lifting and storing an article in a suspended storage position, the overhead lift storage device comprising:
a pulley system;
at least one cable-like element running through the pulley system and comprising a connecting end for attachment to an article to be lifted and a fixed end for attachment to a support;
a threaded rod adapted to be mounted overhead on an elevated support, said rod being rotatable to operate the pulley system to raise or lower said connecting end of said at least one cable-like element, for moving said article between a lowered position and a elevated suspended storage position, the threaded rod comprising an interface end for receiving input force to rotate the threaded rod; and
a weight limiting clutch operably connected with said pulley system to limit an amount of said input force that can be transmitted to the pulley system via said interface end of said rod.

2. The overhead lift storage device of claim 1, further comprising a safety catch for each cable-like element, the safety catch being configured for selective engagement with the cable-like element to remove the load imparted by the article on the pulley system.

3. The overhead lift storage device of claim 2, wherein the connecting end of each cable-like element comprises a support shoulder for engagement with the safety catch.

4. The overhead lift storage device of claim 3, wherein the safety catch is pivotally mounted and pivots between an engaged position, whereby the safety catch engages the support shoulder and removes the tension imparted on the cable-like element by a suspended article, and a disengaged position, whereby the support shoulder can be lowered without engaging the safety catch.

5. The overhead lift storage device of claim 4, wherein the safety catch is biased in the engaged position.

6. The overhead lift storage device of claim 5, further comprising a disengaging cable in operational communication with each safety catch for moving each safety catch from the engaged position to the disengaged position.

7. The overhead lift storage device of claim 6, wherein the disengaging cable is configured to synchronously move each safety catch from the engaged position to the disengaged position.

8. The overhead lift storage device of claim 1, further comprising an overhead longitudinal track for housing at least a portion of the threaded rod.

9. The overhead lift storage device of claim 8, wherein the overhead longitudinal track is further configured for guiding movement of the weight limiting clutch resulting from the rotation of the threaded rod.

10. The overhead lift storage device of claim 8, wherein the overhead longitudinal track is further configured for mounting of the safety catch of any one of claims 2 to 6.

11. The overhead lift storage device of claim 1, wherein the pulley system comprises at least one fixed pulley and a moveable pulley, the moveable pulley controlled by rotation of the threaded rod for moving an article between a lowered connecting position and a suspended storage position via the at least one cable-like element.

12. The overhead lift storage device of claim 1, comprising at least two cable-like elements and wherein the pulley system comprises at least one fixed pulley and a moveable pulley for each cable-like element, each moveable pulley controlled by the rotation of the threaded rod for moving an article between a lowered connecting position and a suspended storage position.

13. The overhead lift storage device of claims 11, wherein the moveable pulley is connected to the weight limiting clutch and selective travel of the weight limiting clutch as a result of rotation of the threaded rod moves an article between a lowered connecting position and the suspended storage position via the at least one cable-like element.

14. The overhead lift storage device of claim 13, wherein the pulley system is configured for synchronous travel of each connection end of each cable-like element during travel of the weight limiting clutch.

15. The overhead lift storage device of claim 1, wherein the threaded rod comprises at least one travel limiter.

16. The overhead lift storage device of claim 15, wherein the travel limiter comprises a stop ring or an electronic sensor.

17. The overhead lift storage device of claim 1, wherein the interface end of the threaded rod comprises a flexible segment for flexing the interface end towards a user.

18. The overhead lift storage device of claim 1, wherein a motorized unit is connected to the threaded rod for imparting rotational force to the threaded rod.

19. The overhead lift storage device of claim 1, wherein the interface end further comprises a motorized unit for imparting rotational force to the threaded rod.

20. The overhead lift storage device of claims 18 or 19, wherein the motorized unit is selected from the group comprising: a power tool, a pneumatic tool and a hydraulic tool.

21. The overhead lift storage device of claim 20, wherein the power tool is an electric drill.

22. The overhead lift storage device of claim 1, wherein the interface end comprises an extension for manual operation by a user.

23. The overhead lift storage device of claim 1, wherein the pulley system is configured to provide a lifting ratio of 1:1, 1:2, 1:3, 1:4, 2:1, 3:1 or 4:1.

24. The overhead lift storage device of claim 1, wherein the pulley system comprises a block and tackle.

25. The overhead lift storage device of claim 1, wherein an opposite end of each cable-like element is anchored.

26. The overhead lift storage device of claim 1, comprising two cable-like elements, each with a connecting end for connection to an article to be lifted.

27. The overhead lift storage device of claim 1, further comprising a Y-cable for attachment to the connecting end of each cable-like element.

28. The overhead lift storage device of claim 1, wherein the cable-like element is selected from the group comprising: a chain, a cable, a rope and a belt.

29. The overhead lift storage device of claim 28, wherein the pulley system comprises pulleys configured for use with a cable-like element selected from the group comprising: a chain, a cable, a rope and a belt.

30. The overhead lift storage device of claim 1, wherein the cable-like element comprises steel, nylon, stainless steel or alloy.

31. The overhead lift storage device of claim 1, wherein the pulley system comprises nylon pulleys, steel pulleys, aluminum pulleys, plastic pulleys or stainless steel pulleys.

32. The overhead lift storage device of claim 8, wherein the overhead longitudinal track is configured for overhead mount to a ceiling, boom, truss, scaffold, or beam.

33. A kit of parts comprising the overhead lift storage device of any one of claims 1 to 32 and instructions for assembly and use to lift and store an article.

34. A tire clamp for seating a tire of a vehicle to be lifted by the lifting device described in claim 1, the tire clamp comprising:
a pair of opposing clamp elements connected to each other at or near their base to define a seat for receiving a tire;
a support bracket connected to each clamp element comprising a lifting point for attachment to the lifting device.

35. A lifting frame for seating and supporting a forward pair and rearward pair of tires of a vehicle to be lifted by a lifting device, the lifting frame comprising:
a pair of side beams for placement on exterior sides of the tires;
a pair of cross beams, each pair comprising a forward cross beam for placement in front of a pair of tires and a rear cross beam for placement behind a pair of tires, the forward cross beam, the rear cross beam and the pair of side beams defining seats for the tires of a vehicle; and
a set of lifting points for attachment to a lifting device.

36. A weight limiting clutch for selectively transferring rotational force of a threaded rod running therethrough into longitudinal movement, the weight limiting clutch comprising:
a clutch housing comprising a longitudinal bore therethrough;
a nut assembly longitudinally slidable and rotatably mounted in the longitudinal bore of the clutch housing, the nut assembly comprising:
a longitudinal threaded bore therethrough for receiving and engaging the threaded rod; and
an exterior shell;
a clutch engaging pin moveable between an engaged position whereby the clutch engaging pin is engaged with the exterior shell of the nut assembly and rotation of the nut assembly with the threaded rod is prevented resulting in longitudinal travel of the weight limiting clutch along the threaded rod, and a disengaged position whereby the pin is disengaged from the exterior shell of the nut assembly and the nut assembly can rotate freely with the rotation of the threaded rod and the disengaged position is achieved through longitudinal sliding of the nut assembly under load and through movement of the clutch engaging pin away from the exterior shell of the nut assembly;
a nut assembly biasing means for longitudinally biasing the nut assembly in the engaged position; and
a clutch engaging pin biasing means for biasing the clutch engaging pin in the engaged position;
wherein the weight limiting clutch transfers rotational force input by the threaded rod into longitudinal movement when in the engaged position and disengages the threaded rod when either the threaded rod provides enough force to overcome the nut assembly biasing means and/or the clutch engaging pin biasing means.

37. The weight limiting clutch of claim 36, wherein the nut assembly biasing means comprises:
a clutch yoke longitudinally slidable in the longitudinal bore and in operational communication with the nut assembly;
a first set of pivotally mounted cogs opposing a second set of pivotally mounted cogs;
a cog pin operatively connecting the clutch yoke and the first and second set of cogs for pivoting the cogs away and towards each other during longitudinal travel of the clutch yoke;
a spring attached to each end of each opposing cog of the first and second set of cogs for biasing the nut assembly in the engaged position.

38. The weight limiting clutch of claim 37, wherein the first and second cog sets each comprise two pivotally mounted cogs.

39. The weight limiting clutch of claim 37, wherein the first and second cogs sets are configured as a trip mechanism to move the clutch yoke between the engaged position and the disengaged position.

40. The weight limiting clutch of claim 37, wherein the spring is adjustably attached to each end of each opposing cog.

41. The weight limiting clutch of claim 39, wherein the nut assembly biasing means further comprises a spring sleeve for tripping the clutch yoke from the disengaged position to the engaged position.

42. The weight limiting clutch of claim 41, wherein the spring sleeve is a urethane spring sleeve.

43. The weight limiting clutch of claim 36, wherein the clutch engaging pin biasing means comprises:
a trip mechanism for moving the engaging pin between the engaged position and the disengaged position;
a spring for biasing the trip mechanism in the engaged positioned.

44. The weight limiting clutch of claim 36 further comprising a thrust bearing longitudinally slidable in the longitudinal bore adjacent the nut assembly.

45. The weight limiting clutch of claim 36, further comprising a safety nut for selectively lockable connection with the nut assembly, the safety nut being longitudinally slidable and rotationally mounted in the longitudinal bore of the clutch housing adjacent the nut assembly and having a longitudinal threaded bore therethrough for receiving and engaging the threaded rod.

46. The weight limiting clutch of claim 45, wherein the longitudinal threaded bore of the safety nut is over-bored to reduce the heat build up between the threaded rod and the safety nut.

47. The weight limiting clutch of claim 45, wherein the safety nut and the threaded rod are dissimilar metals.

48. The weight limiting clutch of claim 45, wherein the safety nut is brass.

49. The weight limiting clutch of claim 36 further comprising a guide, the guide comprising a guide arm interface with a track to longitudinally guide the weight limiting clutch when in the engaged position.

50. The weight limiting clutch of claim 49, wherein the guide further comprises a guide button for interface with a track to prevent rotation of the weight limiting clutch when in the engaged position.

51. The weight limiting clutch of claim 36, wherein the longitudinal threaded bore of the nut assembly comprises a nylon insert, a Teflon insert or a plastic insert.

52. The weight limiting clutch of claim 36, wherein the external shell of the nut assembly comprises steel.
